(19) United States
(12) Patent Application Publication
(10) Pub. No.: US 2004/0204105 A1
(43) Pub. Date: Oct. 14, 2004

(54) Method and apparatus for a base station with multiple distributed antennas to communicate with mobile stations

(76) Inventors: Ying-Chang Liang, Santa Clara, CA (US); Fadi Boutros Baaklini, Sunnyvale, CA (US); Richard Joseph Marino, Milpitas, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/219,676

(22) Filed: Aug. 14, 2002

Related U.S. Application Data
(60) Provisional application No. 60/383,497, filed on May 24, 2002.

(51) Int. Cl. H04B 1/38

(52) U.S. Cl. 455/562.1; 455/101; 455/277.1

(57) ABSTRACT

A multiple distributed antenna access point (MDA/AP) system which compensates for wireless path loss and increases data throughput between AP and mobile user stations includes a central unit including one or more central antennas, a distributed antenna unit including multiple distributed antennas and an auxiliary unit interfacing the central unit with the distributed antenna unit, with each unit being separate or the central and auxiliary units being integrated. The central unit functions as a traditional access point and is operable in time division duplex (TDD) or frequency division duplex (FDD) mode. One or more central or distributed antennas are utilized to transmit and receive signals to and from the mobile user stations where selection of the antenna(s) used for a given mobile user station determines the throughput of the transmission. A method for selecting an antenna for optimal performance of the MDA/AP system using a CSMA/CA distributed coordination function (DCF) communications protocol includes employing one or more control antennas of the MDA/AP system during an RTS or CTS period and selecting one or more antennas during a data period.

### CROSS-REFERENCE TO RELATED APPLICATIONS

The present application claims the benefit of U.S. Provisional Patent Application No. 60/383,497, filed May 24, 2002, entitled “METHOD AND APPARATUS FOR A BASE STATION WITH MULTIPLE DISTRIBUTED ANTENNAS TO COMMUNICATE WITH MOBILE STATIONS,” which is herein incorporated by reference in its entirety.

### FIELD OF THE INVENTION

The present invention relates to the field of wireless communication systems, and more particularly, to a method and apparatus for a base station with multiple distributed antennas to communicate with multiple mobile stations. The present invention relates to a wireless solution integrating wired and wireless technologies to compensate for wireless path loss and to increase the system throughput for any user within the cell.

### BACKGROUND

In a wireless communication system, a signal transmitted from one station to another suffers from propagation attenuation, which consists of three components, distance-dependent path loss, slow shadow fading due to blocking objects, and fast multipath fading due to movement of the stations and/or the change of the environment. As such, one base station can only provide wireless service to users within one area with limited coverage, which is called one cell. A base station serves multiple mobile stations within the cell based on one or more multiple access schemes. The ultimate goal for wireless system design is to provide maximum system capacity yet with broadest area coverage.

Each mobile user is allocated a specific physical channel, time slot, frequency band, spreading codes, or their combinations to share the same base station. Specifically, there are two kinds of multiple access schemes: guaranteed multiple access and random multiple access. Guaranteed multiple access schemes consist of code division multiple access (CDMA), frequency division multiple access (FDMA) and time division multiple access (TDMA). In CDMA systems, all mobile users are allocated different spreading codes. Different frequency band is allocated to different user for FDMA systems; while for TDMA, each user is allocated specific time slots for transmitting and receiving information. Usually, a TDMA system is also incorporated with FDMA scheme to increase the system capacity. That is to say, one base station is assigned multiple frequency bands, each of which serves for multiple mobile users using TDMA scheme. For random access, one method is based on carrier sense multiple access (CSMA). Its advanced version includes CSMA with collision detection CSMA/CD typically used in wired local area networks (LAN), and CSMA with collision avoidance (CSMA/CA) adopted in wireless LAN.

Two-way communications systems require separate channels for uplink and downlink. Typically, two classes of duplexing methods are employed: time-division-duplexing (TDD) and frequency-division-duplexing (FDD). For TDD, both links make use of the same frequency band, but occupy different time slot; for FDD, two separate frequency channels are allocated for each link.

To prevent cells from interfering with each other, the neighboring cells should be allocated different frequency bands in TDMA and FDMA systems. In CDMA systems, all cells can employ the same frequency band, but each of them should be assigned a different set of long scrambling codes, with which the inter-cell interference is maintained at a low level.

However, frequency bandwidth is always a limited resource, and one frequency channel has to be reused in cellular communication systems. Thanks to the propagation attenuation, in fact, the same frequency band can be reused for sufficiently apart cells as long as the interference from the co-channel cells is small enough.

The neighboring cells can be overlapped to provide better quality of service (QoS) to the users within its coverage. This is because that normally, the closer the mobile user is located to the serving base station, the less the propagation loss the signal is experiencing, and therefore, with same transmitted power at the base station, the larger received power can be obtained, by which better BER performance can be achieved for that mobile user.

However, the smaller the cell size, the more base stations are required to cover a given area, incurring higher operating cost for the service provider. Further, the smaller cell size would introduce larger co-channel interference due to frequency reuse, which may degrade the overall cellular performance.

Wireless Local Area Networks (WLAN)

For wireless LAN systems, according to FCC regulation, there is a limit on the transmission power at the transmit antenna, e.g., 40 mW for 5.15 GHz-5.25 GHz frequency band in North America, thus by transmitting this power at the AP antenna, users close to the AP in general can get high link data rate and thus high throughput; while users far away from the AP, the low link data rate and low throughput.

The achievable throughput for users located at the same distance from the AP varies with different spatial locations. This is because that even though these users may experience same distance-dependent path loss, the shadow fading varies for different spatial locations due to different blocking environment. As such, a typical cell shape is not a regular circle.

For WLAN systems, all users belonging to the same AP share the same frequency channel, but contend the time slot for up and down link transmissions based on CSMA/CA protocol. Because of this, the low rate users affect the throughput and delay performance of the whole system significantly. In fact, if a user with low link data rate is going to download a huge file, it will need large number of time slots, and once this user has contended the channel, all the others have to wait for a long time to get the right to use the channel.

Therefore, there is a need to increase the link data rate yet maintaining the transmission/reception performance (e.g., bit error rate, or symbol error rate), for users located anywhere within the cell.

### SUMMARY

The present invention is directed to a wireless solution by integrating wired and wireless technologies to compensate wireless path loss and to increase the system throughput for any user within the cell. The preferred embodiment of this invention incorporates one central unit having one or more central antennas attached thereto, which forms the functionalities of a traditional access point (or base station), one local antenna/cable unit, which consists of multiple local antennas with RF cables, and one auxiliary unit, which interfaces the wired cables with the central unit. The local antenna/cable unit can also be referred to as a distributed antenna/cable unit having multiple distributed antennas with associated RF cables. Accordingly, the terms local and distributed antenna(s) can be used interchangeably hereinafter. Central and distributed antennas are configured to one or more frequency bands. Through the use of wired cables to solve the shadowing problem, the users far away from the central antenna(s), or having large shadow fading from the central antenna(s), can also achieve high throughput as the transmission power in the distributed antenna for those users can be set at the limit same as the central antenna(s) in the central unit. Power amplifiers are used at both ends of the cable to compensate the cable losses.

Novel solutions with simplified implementations are designed as well. These solutions require only one set of RF transceiver, baseband processor and MAC processor. The central unit alone can work as an independent access point; while the auxiliary unit and distributed antenna/cable unit can be plugged into the central unit and work as a multiple distributed antenna access point (MDA/AP) together with the central unit. It is flexible to plug into different number of distributed antennas in the distributed antenna/cable unit. The MDA/AP can have single or multiple RF chains.

Also, besides time-division duplex (TDD) based MDA/AP, frequency division duplex (FDD) based MDA/AP is described as another embodiment of the present invention.

In wireless LAN systems, the access point serves different users in different time periods depending on CSMA/CA protocol. At least one antenna has to ensure that the transmitted control signals, such as RTS and CTS signals, will be correctly received by all users within the cell. The central and distributed antennas of the MDA/AP system of the present invention can function in this manner, and when doing so the antennas can be referred to as control antennas. When the MDA/AP of a preferred embodiment of the present invention is operative, one or more control antennas stay in “always-on” status so that the MDA/AP can listen to the channel and answer the request, while each distributed antenna takes effect when the user being served is within its area of service. In one preferred embodiment, different frame periods can have different control antennas.

Traditionally, when a user is going to access a wireless LAN network, it chooses the best access point from all neighboring APs. However, if the best AP is a MDA/AP, it is further required to locate the best antennas supported by the MDA/AP. For traditional access points, when the user is close to the AP, a high order modulation, e.g., 64 QAM, is used to provide high link data rate; while for far away users or users with large shadow fading, low order modulation, e.g., BPSK is used to convey low link data rate signals.

New signaling is designed in accordance with the MDA/AP of the preferred embodiment of the present invention. In accordance with the present invention, all selected antennas will transmit a same signal, typically with high order modulation, say 64 QAM. This is because from the user's perspective, it looks like the transmitted signal has passed through a wireless channel whose response is a combination of those from all selected antennas to the user. Thus at the user's side, a traditional base band processor is able to recover the transmitted symbols, without requiring modification by the base band processor. Therefore, when a distributed antenna is used to serve the user, the control antenna will adopt a high order modulation no matter how far away from the central antenna the user is located.

### BRIEF DESCRIPTION OF THE DRAWINGS

These and other features, aspects, and advantages of the present invention will become better understood with regard to the following description, and accompanying drawings in which:

FIG. 1 shows a traditional throughput-range relation for IEEE802.11a based wireless LAN systems;

FIG. 2 shows a traditional wireless LAN systems with seven access points (APs) to provide no less than 36 Mbps link data rate, each AP configured to one frequency band;

FIG. 3 shows a multiple distributed antenna access point (MDA/AP) configured to only one frequency band and with one central antenna and six local antennas in accordance with a preferred embodiment of the present invention;

FIG. 4 is an electrical schematic of a TDD based super access point with local antennas for both uplink and downlink purposes in accordance with one embodiment of the present invention;

FIG. 5 shows antenna deployment schemes relative to transmission periods using CSMA/CA distributed coordination function (DCF) uplink (from user side to MDA/AP) in accordance with one embodiment of the present invention.

FIG. 6 shows antenna deployment schemes relative to transmission periods using CSMA/CA DCF downlink (from MDA/AP to user side) in accordance with one embodiment of the present invention;

FIG. 7 is a simplified schematic diagram of a local antenna/cable unit for a TDD MDA/AP in accordance with one embodiment of the present invention;

FIG. 8 is a simplified schematic diagram of a local antenna/cable unit for a TDD MDA/AP in accordance with an alternative embodiment of the present invention;

FIG. 9 is a simplified schematic diagram of the local antenna/cable and an auxiliary unit for a TDD MDA/AP according to principles of the present invention;

FIG. 10 is a simplified schematic diagram showing another embodiment of the local antenna/cable unit and an auxiliary unit for a TDD MDA/AP in accordance with the present invention;

FIG. 11 is a schematic diagram of a frequency division duplex (FDD) based super access point in accordance with an embodiment of the present invention;

FIG. 12 is a schematic diagram of a local antenna/cable unit and an auxiliary unit for an FDD MDA/AP in accordance with the present invention; and

FIG. 13 is a schematic diagram showing another embodiment of the local antenna/cable unit and an auxiliary unit for an FDD MDA/AP in accordance with the present invention.

### DETAILED DESCRIPTION OF THE INVENTION

The description and the drawings set forth herein discuss one or more currently preferred embodiments and also describe some exemplary optional features and alternative embodiments. The description and drawings are for the purpose of illustration and not limitation. While the present invention is applicable to other communications systems, wireless LANs will be used to describe one embodiment of the present invention. In the following description, reference to the drawings will use the same reference numerals for like features.

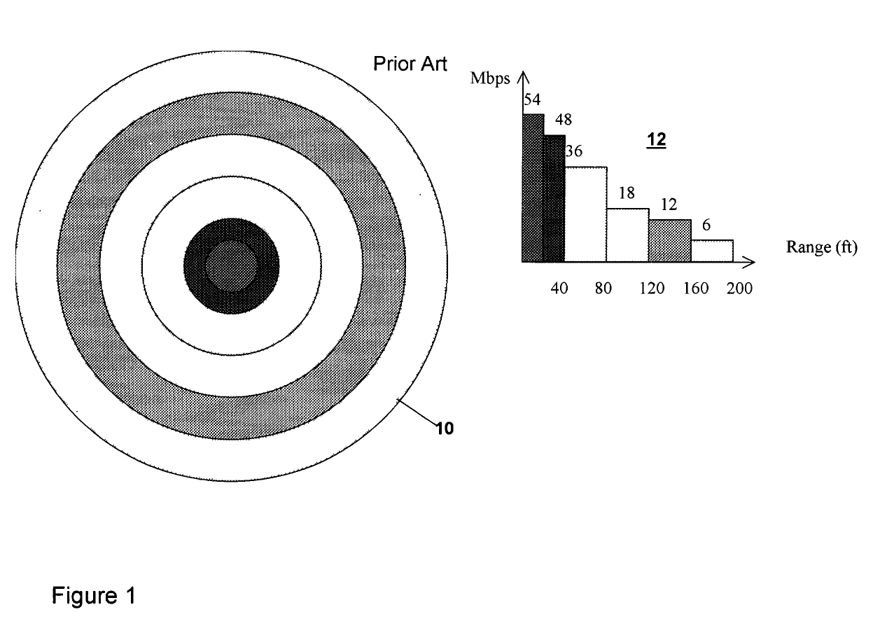

FIG. 1 shows the relationship between achievable link data rate, in Mbps, and the distance between the user and AP for a typical wireless LAN system based on IEEE 802.11a standard. The relationship is shown both spatial 10 and graphical 12 formats. This relation is measured for indoor environment with fixed transmission power at the AP, and it becomes clearer in accordance with Table I. It is seen that, even though IEEE 802.11a claims that it can support 54 Mbps data rate, this data rate is achievable only when the distance between the user and AP is within 20 ft; however when the user is located about 200 ft far away from the AP, only 6 Mbps data rate is achievable.

TABLE I

| | | | | | | |
|---|---|---|---|---|---|---|
| Distance | 0-20 | 20-40 | 40-80 | 80-120 | 120-160 | 160-200 |
| (ft) | | | | | | |
| Data rate | 54 | 48 | 36 | 18 | 12 | 6 |
| (Mbps) | | | | | | |

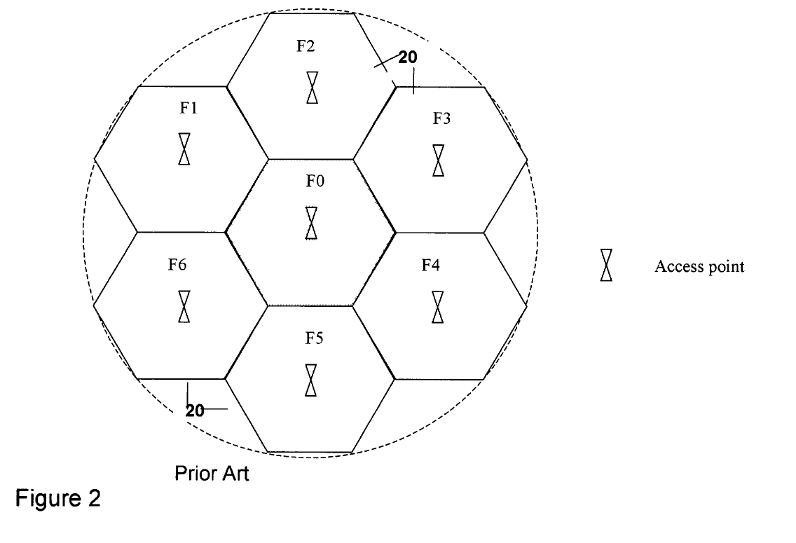

FIG. 2 illustrates the traditional method for arranging multiple APs 20 to provide more than 36 Mbps link data rate for every user within the same area shown in FIG. 1. This method requires seven (7) traditional APs 20, each of which being configured to one different frequency band to avoid co-channel interference from each other

For North American, eight non-overlapping frequency channels are available for 5 GHz band; however, in other countries, such as Japan, IEEE802.11a is allocated four non-overlapped channels only. Arranging APs using a traditional method yields large co-channel interference, thus reducing system throughput for cellular environments, especially when the available channels are limited. On the other hand, the throughput increment is achieved by increasing the overall cost to seven times, and by sacrificing the coverage since in this scenario the seven APs 20 are used to cover the same area that one AP covers in FIG. 1.

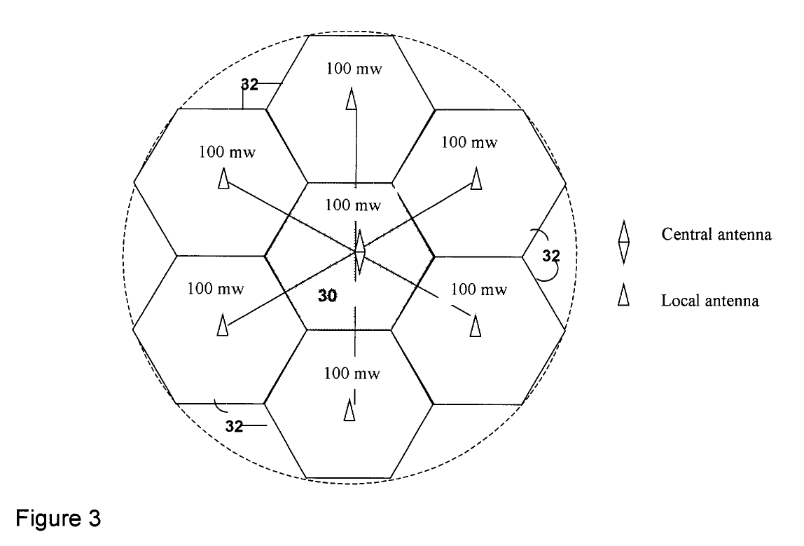

FIG. 3 shows the preferred embodiment of the present invention using one access point 30 having a central antenna and six local, or distributed, antennas 32 to provide more than 36 Mbps link data rate for the whole area shown in FIG. 1. Six distributed antennas 32 have been chosen for illustrative purposes only, and it will be recognized by those skilled in the art that the number of distributed, or local, antennas can be varied. While each antenna can be configured to different frequency band if each of them has its own RF transceiver, to minimize hardware complexity, the preferred embodiment makes use of single frequency band for all antennas, thus is considered as a multiple distributed antenna access point (MDA/AP).

The preferred embodiment of the present invention is a wireless solution in general, however, it compensates path loss effect using wired technology. In fact, through the use of the wired cable, the radiated RF power in the working distributed antenna can be set as high as that in the central antenna. Therefore, the preferred embodiment of the present invention is a hybrid wireless and wired system, providing increased throughput for all users within the cell.

Several other embodiments in accordance with principles of the present invention are described hereinbelow.

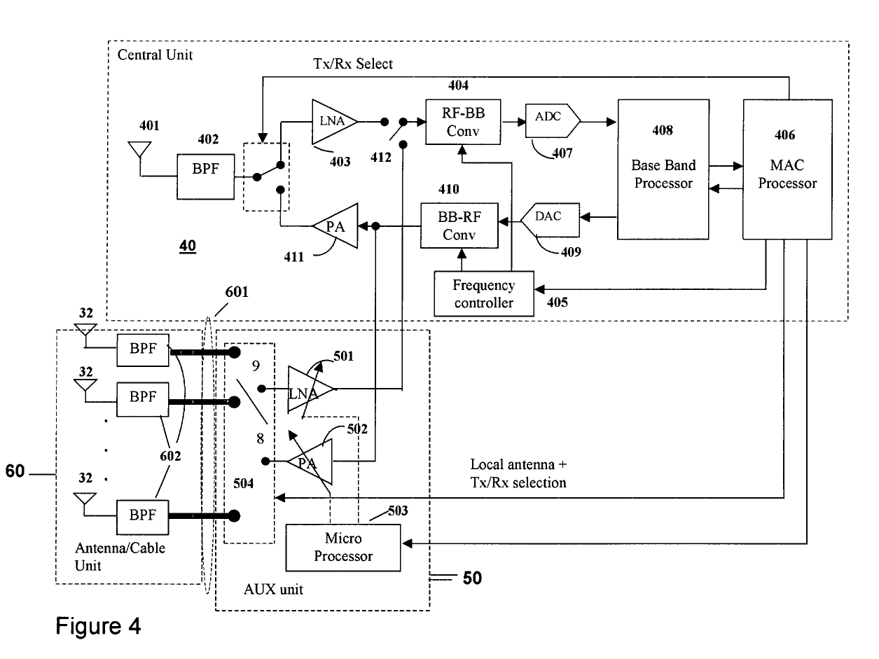

One embodiment sets forth a time-division-duplex (TDD) MDA/AP system with distributed antennas used for both uplink and downlink transmissions. Referring to FIG. 4, illustrated therein is a time-division duplex (TDD) transceiver of the MDA/AP in accordance with one embodiment of the present invention. It consists of three main parts: a central unit 40, an auxiliary unit 50 and a distributed antenna/cable unit 60. The central unit 40, shown in FIG. 4, includes one central antenna 401, but can include more than one central antenna 401. The central unit 40 functions as a traditional TDD access point. In operation, an RF signal is transmitted and received with a central antenna 401, where Tx/Rx mode is switched with the control from a MAC processor 406. During the receiving mode, the received signal from the central antenna 401 is first passed to a bi-directional BPF 402 to suppress the interference and additive noise out of the frequency band. The filter output is then sent to the low-noise-amplifier (LNA) 403. The LNA output is then passed to a down converter 404 whose working frequency is controlled by the frequency controller 405. The frequency controller 405 accepts input from the MAC processor 406. The output from the down converter 404 is then passed to an analog to digital converter (ADC) 407. Then, the digitalized signal from the ADC 407 is sent to the base band processor 408 to recover the useful information. During transmission mode, the base band modulated digital signal is first passed to a digital-to-analog converter (DAC) 409, whose output is then sent to the up converter 410. The up converter 410 transforms baseband analog signal to the RF signal whose operating frequency is controlled by the frequency controller 405, which is further adjusted by the MAC processor 406. The RF signal from the up converter output is then passed to a power amplifier (PA) 411, and then to the bi-directional BPF 402 and the antenna 401.

The auxiliary unit 50 of this embodiment of the present invention consists of one LNA 501, one PA 502, one microprocessor 503, and one distributed antenna plus Tx/Rx switch 503. The microprocessor 503 receives commands from the MAC processor 406 of the central unit 40, and measures the path gains from the user to each distributed antenna 32. The measured path gains through each distributed antenna 32 are used to determine the best distributed antenna to the particular user, (the best distributed antenna is going to serve the particular user), and to determine the amplifier gains of the LNA 501 and PA 502 when used. The amplifier gains are adjusted so that the transmitted power at the distributed antenna will not exceed the power limit in accordance with the FCC regulation or with a different country's rule, after compensating the cable loss, which is different when a different distributed antenna is selected.

The distributed antenna plus Tx/Rx switch 504 of the embodiment of the present invention, on one end, selects one cable 601 from six depending on which distributed antenna 32 is used to serve the users for that moment, and on the other end, switches in between Tx/Rx mode. The connection status of the switch is controlled by the MAC processor 406 or the microprocessor 503. The PA 502 gets a signal from the BB-RF converter 410 output in the central unit 40. The LNA 501 output sends a signal to the RF-BB converter 404 input in the central unit 40. A switch 412 is used to control the input to the RF-BB converter 404 in the central unit 40. It selects signals either from the central antenna branch, or from the distributed antenna branch. There is a BPF 602 in between the distributed antenna 32 and the cable 601. The BPF 602 here is a passive BPF if no DC power is sent to the distributed antenna/cable unit 60 from the central unit 40.

There are six distributed antennas 32 acting as transmitting and receiving tools in FIG. 4. In practice, the number of distributed antennas 32 varies depending on the overall system design. The distributed antennas 32 connect with band pass filters 602, which further link with the wired cables 601. When used for distributed coordination function (DCF) mode, the MDA/AP makes use of different antennas for uplink (from user to MDA/AP) reception and downlink (from MDA/AP to user) transmission.

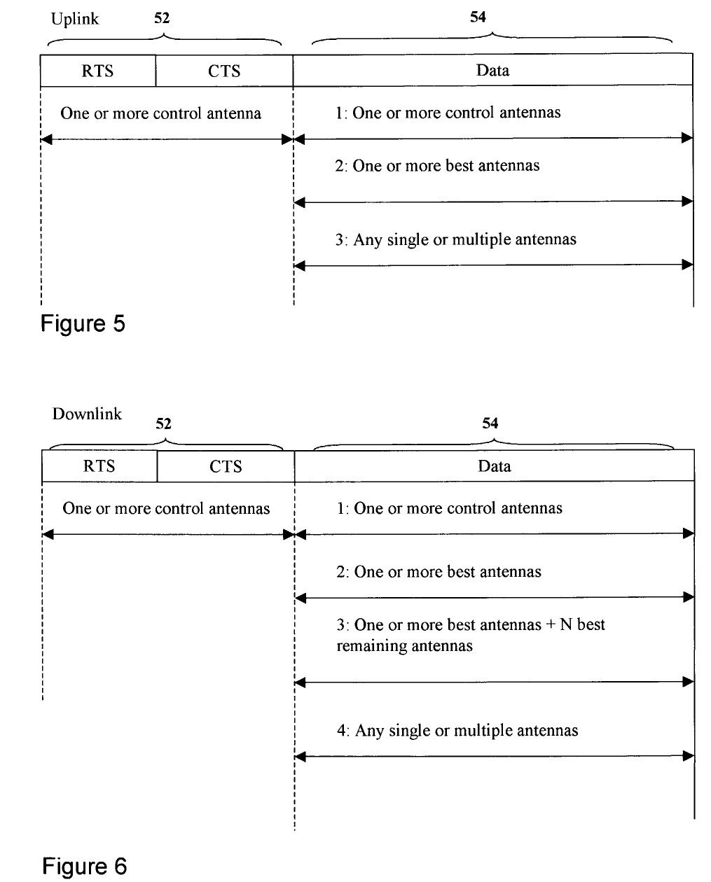

FIG. 5 illustrates antenna deployment using CSMA/CA DCF protocol for uplink events in accordance with an embodiment of the present invention. One or more control antennas are used during a request-to-send (RTS) or clear-to-send (CTS) period 52, while for a data receiving period 54 one or more antennas can be used. The control antennas can be central antennas or distributed antennas of the MDA/AP. Described herein are three exemplary schemes for selecting the antenna to use. The first deployment scheme uses one or more control antennas following the traditional way. The second deployment scheme sets forth a best antenna being selected through a switch or N best antennas being combined. Finally, the third scheme utilizes any single antenna selected through a switch or any multiple antennas combined through a combiner. The best antenna, which is mobile user dependent, is determined as follows. First, the received signal strength index (RSSI) for each antenna is measured during the reception of RF signals for the particular mobile user. Then, the antenna with the highest RSSI is considered as the best antenna for the measured mobile user. Additional criteria for determining the best antenna can be set forth, such as setting a threshold value above which the measured RSSI must be. The best antenna can be any central antenna or distributed antenna. The N best antennas are the antennas whose RSSIs are the N largest values for the particular mobile user.

FIG. 6 shows similar antenna deployment using CSMA/CA DCF protocol for downlink events in accordance with another embodiment of the present invention. As in the uplink scenario, here one or more control antennas are also used during the RTS and CTS period 52, while during the data transmission period 54, the same format of signals is sent through all selected antennas through a splitter to prevent signals from interfering with each other.

The first two antenna deployment methods used for uplink scenario can be applied into downlink as well. However, there are some other methods specifically designed for downlink where one or more control antennas are always selected. One method is to select one or more control antennas and N best remaining antennas, which are the antennas whose RSSIs are the N largest values for the particular mobile user without considering the control antenna(s) employed for that frame period. Finally, a general downlink method according to principles of the present invention utilizes any single antenna through a switch or any multiple antennas through a splitter.

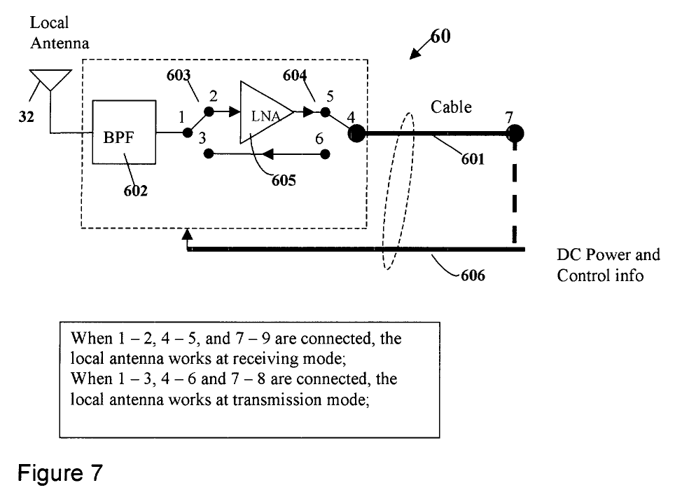

An implementation of the local, or distributed, antenna/cable unit 60 for a TDD MDA/AP system in accordance with the present invention can be seen in FIG. 7. Here the right end of the cable 601 directly connects with the local antenna plus Tx/Rx switch located in the auxiliary unit (not shown), while in between the local antenna and the left end of the cable, there are two switches 603, 604 and one LNA 605. When 1-2, 4-5, 7-9 are connected, the local antenna 32 operates in receiving mode. The received signal from the local antenna 32 first passed to the BPF 602, then sent to the LNA 605 to compensate the path loss due to the cable. When 1-3, 4-6, 7-8 are connected, the local antenna 32 operates in transmission mode. A separate cable 606 is used in this embodiment to convey DC power and control information to the local antenna/cable unit 60.

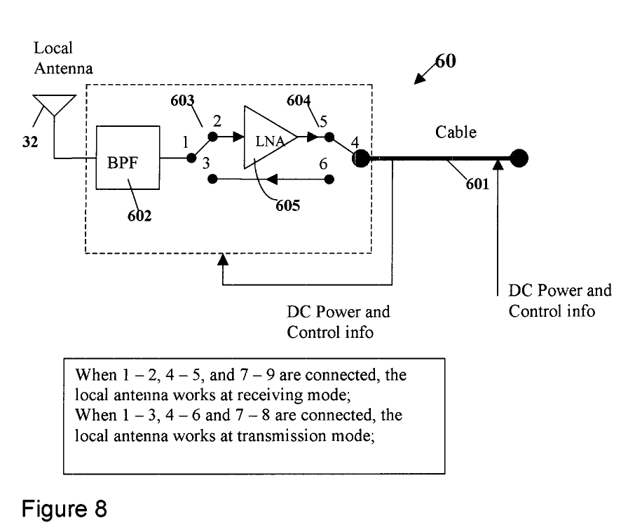

FIG. 8 shows an alternative embodiment of a local antenna/cable unit 60 implementation for a TDD MDA/AP system in accordance with the present invention. The difference between FIG. 8 with FIG. 7 is that in FIG. 8, only one cable 601 is employed to convey the DC power, the control information used for each local antenna/cable unit, and the uplink/downlink RF signals. At the auxiliary unit end, the DC power and control information is injected into the cable 601; while at the local antenna/cable unit, the DC power and control information is taken out first, then used to support the local antenna/cable unit.

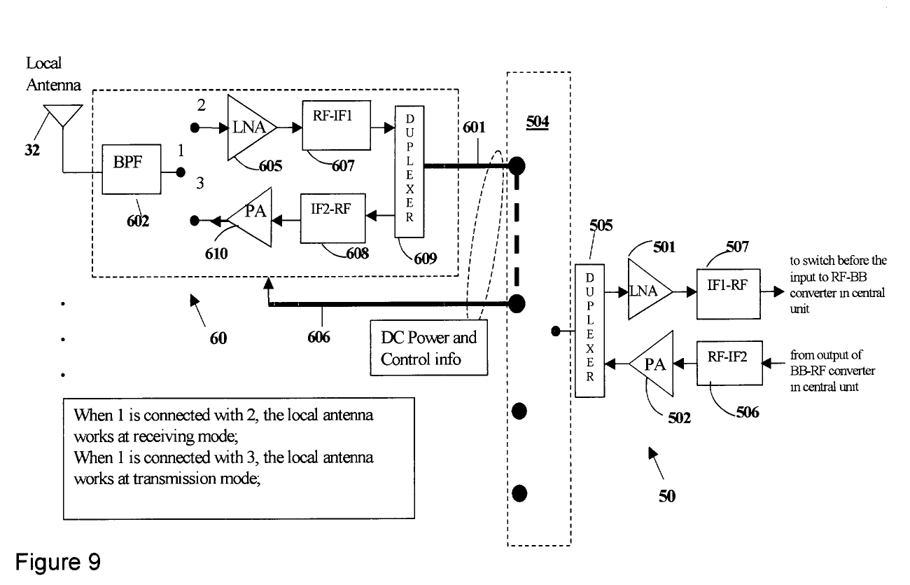

FIG. 9 illustrates an alternative embodiment of the local antenna/cable unit 60 plus the auxiliary unit 50 for a TDD MDA/AP system in accordance with the present invention. In the auxiliary unit 50, a duplexer 505 is used to interface the local antenna/cable switch 504, the LNA 501 input, and the PA 502 output. The signal coming from the output of the BB-RF converter 410 of central unit 40 shown in FIG. 4, is first passed to an RF-IF2 converter 506, then to the PA 502, further to the duplexer 505. The central frequency of the RF-IF2 506 output is IF2. The signal from the duplexer 505 output (whose central frequency is IF1) is passed to the LNA 501, then to an IF1-RF converter 507, whose output is further sent to the switch 412 in between the LNA 403 and the RF-BB converted 404 in the central unit 40 (shown in FIG. 4). For the local antenna/cable unit 60, when 1 is connected with 2, the local antenna 32 operates in receiving mode; when 1 is connected with 3, the local antenna 32 operates in transmitting mode. A duplexer 609 is used to interface the left end of the cable 601, an RF-IF1 converter 607 output, and an IF2-RF converter 608 input. The received signal from the local antenna 32 is first passed to the BPF 602, then to the LNA 605, then to the RF-IF1 converter 607. The signal received from the cable 601 is first passed to the IF2-RF converter 608, then to a PA 610, and then sent out through the local antenna 32. The DC and control information are sent to the local antenna/cable unit 60 through the separate cable 606.

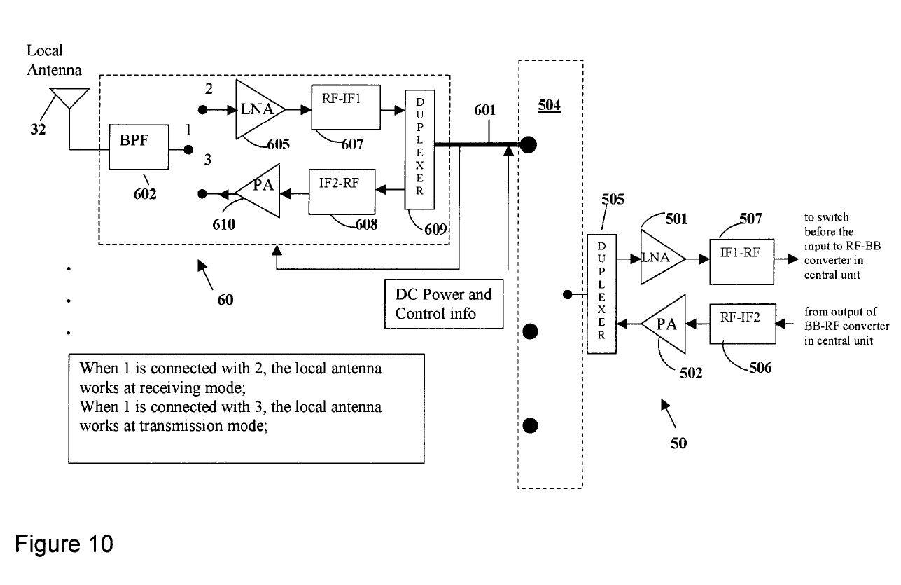

FIG. 10 illustrates a further embodiment of the local antenna/cable unit 60 plus the auxiliary unit 50 for a TDD MDA/AP system in accordance with the present invention. The difference between FIG. 10 with FIG. 9 is that in FIG. 10, only the one cable 601 is employed to convey the DC power, the control information used for each local antenna/cable unit, and the uplink/downlink RF signals. Similar to that described with respect to the embodiment shown in FIG. 8, at the auxiliary unit 50 end, the DC power and control information is injected into the cable 601, while at the local antenna/cable unit 60, the DC power and control information is first taken out, then used to support the local antenna/cable unit 60.

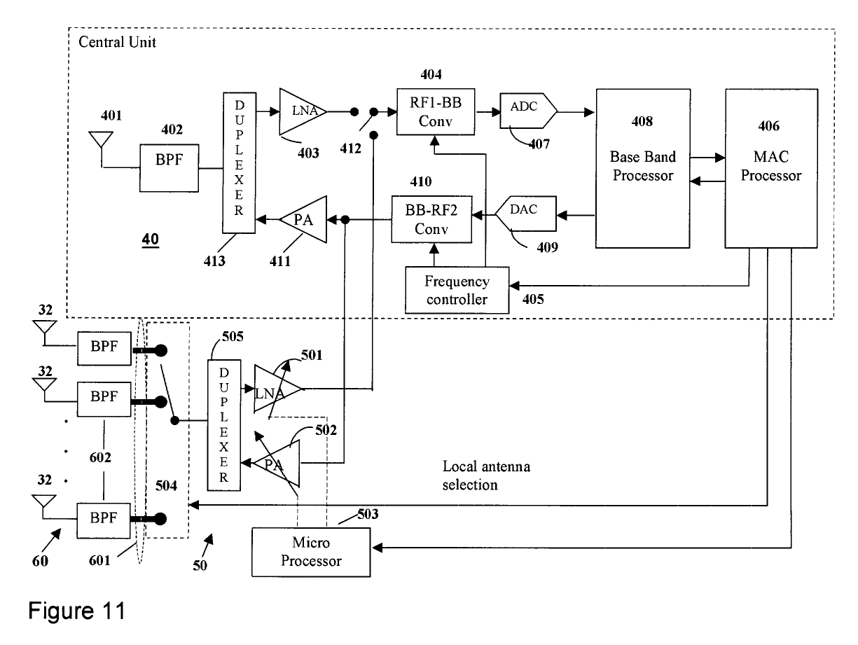

Features of the present invention can also be implemented in frequency-division-duplex (FDD) based MDA/AP systems with local antennas used for both uplink and downlink transmissions. FIG. 11 illustrates an example of a frequency-division duplex (FDD) transceiver of the MDA/AP in accordance with one embodiment of the present invention. As in the TDD based system, the FDD MDA/AP consists of three main parts: a central unit 40, an auxiliary unit 50 and a distributed antenna/cable unit 60.

As shown in FIG. 11, the central unit 40 has the functionality of a traditional FDD access point. Specifically, signal transmission and reception employ the same central antenna 401 using different frequency channels, which are controlled by the MAC processor 406. Similar to the TDD based MDA/AP system shown in FIG. 4, the FDD based system is shown here with a single central antenna 401, but can include more than one central antenna 401. During the receiving mode, the received signal from the central antenna 401 is first passed to the bi-directional BPF 402 to suppress the interference and additive noise out of the frequency band. Next, in this FDD embodiment, the filter output is then sent to a duplexer 413, the output of which is further passed to the low-noise-amplifier (LNA) 403. The LNA output is then passed to down converter 404 whose working frequency is controlled by the frequency controller 405. The frequency controller 405 accepts input from the MAC processor 406. The down converter output is then passed to the analog to digital converter (ADC) 407. Then, the digitalized signal from the ADC 407 is sent to the base band processor 408 to recover the useful information. During transmission mode, the base band modulated digital signal is first passed to the digital-to-analog converter (DAC) 409, whose output is then sent to the up converter 410. The up converter 410 transforms base band analog signal to the RF signal whose operating frequency is controlled by the frequency controller 405, which is further adjusted by the MAC processor 406. The RF signal from the up converter output is then passed to the power amplifier (PA) 411, and then to the duplexer 413, and the bi-directional BPF 402 and the central antenna 401.

The auxiliary unit 50 consists of one LNA 501, one PA 502, one microprocessor 503, one local antenna switch 504 and a duplexer 505. The microprocessor 503 receives commands from the MAC processor 406 of the central unit 40 as well, and measures the path gains of the serving users, and determines the amplifier gains of the LNA 501 and the PA 502 when used. The measured path gains through each local antenna 32 are used to determine which local antenna 32 is going to serve the particular user. The amplifier gains are adjustable to compensate the cable loss. The gain values vary when different local antennas 32 are selected, depending on the length of the corresponding cable, and other parameters, such as, for example, working frequency and cable loss characteristics.

The local antenna switch 504 selects one cable 601 from six (in this illustrated embodiment where six local antennas are set forth) depending on which local antenna 32 is used to serve the users for that moment. The connection status of the switch is controlled by the MAC processor 406 or the microprocessor 503. The PA 502 gets the signal from the BB-RF converter 410 output in the central unit 40. The LNA 501 output sends the signal to the RF-BB converter 404 input in the central unit 40. The duplexer 505 is used to interface the right end of the local antenna switch 504 and the LNA 501 input, the PA 502 output. Referring now to the local antenna/cable unit 60, there is a BPF 602 in between each local antenna 32 and the respective cable 601. The BPF here is preferably a passive BPF if no DC power is sent to the local antenna/cable unit from the central.

For the above embodiment, the cable 601 conveys the RF signals whose frequencies are exactly same as the receiving/transmission frequencies. When the frequencies are high, say 5 GHz band in IEEE 802.11a, the cable loss is very large.

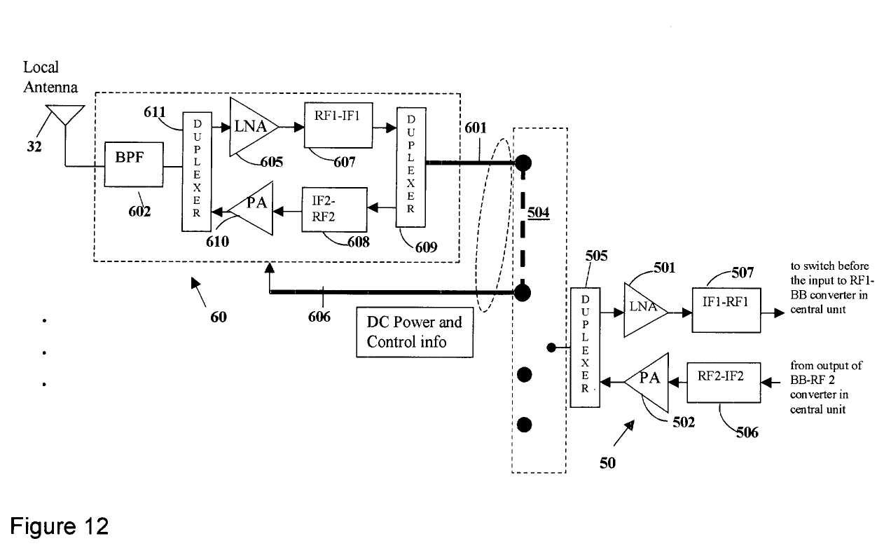

Referring now to FIG. 12, an embodiment of a local antenna/cable unit 60 plus an auxiliary unit 50 for an FDD MDA/AP system in accordance with the present invention is shown. In the auxiliary unit 50, a duplexer 505 is used to interface the local antenna/cable switch 504, the LNA 501 input, and the PA 502 output. The signal coming from the output of the BB-RF2 converter 410 of central unit shown in FIG. 11, is first passed to the RF2-IF2 converter 506, then to the PA 502, and further to the duplexer 505. The central frequency of the RF2-IF2 506 output is IF2. The signal from the duplexer 505 is passed to the LNA 501, then an IF1-RF1 converter 507, whose output is further sent to the switch 412 in between the LNA 403 and the RF1-BB converter 404 in the central unit 40. In the local antenna/cable unit 60, the duplexer 609 is used to interface the left end of the cable 601, the RF1-IF1 converter 607 output, and the IF2-RF2 converter 608 input. There is a second duplexer 611 interfacing the BPF 602 with the input to the LNA 605 and the output of the PA 610. The received signal from the local antenna 32 is first passed to the BPF 602, then to the LNA 605 through the second duplexer 611, then to the RF-1-IF1 converter 607. The signal received from the cable 601 is first passed to the IF2-RF2 converter 608 through the duplexer 609, then to the PA 610, and then sent out through the local antenna 32 after passing through the second duplexer 611 and the BPF 602. The DC and control information are sent to the local antenna/cable unit 60 through a separate cable 606.

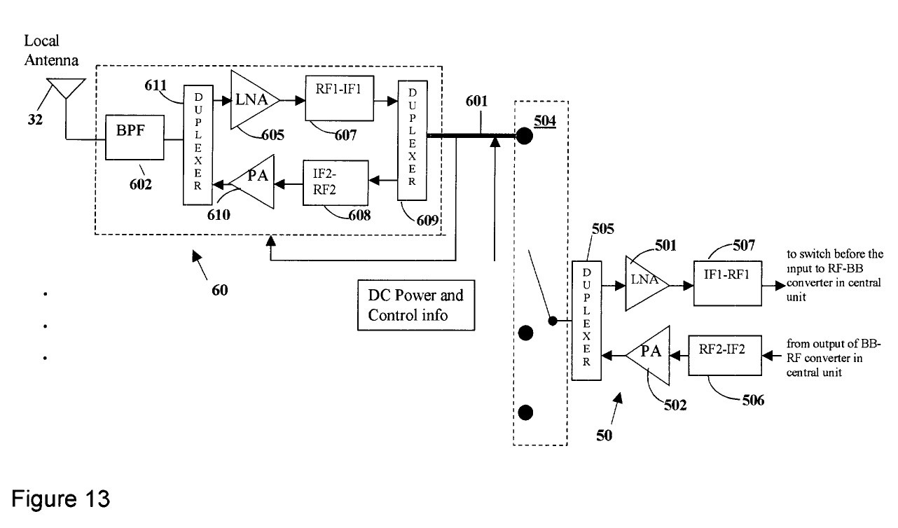

FIG. 13 illustrates another embodiment of the local antenna/cable unit 60 plus auxiliary unit 50 for an FDD MDA/AP system in accordance with the present invention. The difference between FIG. 13 with FIG. 12 is that in FIG. 13, only the one cable 601 is employed to convey the DC power, the control information used for each local antenna/cable unit, and the uplink/downlink RF signals. In the auxiliary unit 50 end, the DC power and control information is injected into the cable 601, while at the local antenna/cable unit 60 end, the DC power and control information is taken out first, then used to support the local antenna/cable unit 60.

Throughout the description and drawings, example embodiments are given with reference to specific embodiments and configurations. However, the present invention is not limited to those specific embodiments or configurations. It will be understood by those skilled in the art that many changes in construction and circuitry and widely differing embodiments and applications of the invention will suggest themselves without departure from the spirit and scope of the invention. The disclosures and the description herein are purely illustrative and are not intended to be in any sense limiting. Rather, the invention is to cover all modifications, equivalents, and alternatives falling within the spirit and scope of the invention as defined by the appended claims.

What is claimed is:

1. A method for a base station having one or more central antennas to provide high link data rate to mobile users within a cell, the method comprising steps of:
deploying at least one distributed antenna within the cell;
receiving signals from each mobile user using one or more antennas; and
transmitting signals for each mobile user using one or more antennas, wherein data throughput increases based on particular antennas being used for a given mobile user.

2. The method of claim 1 further comprising a step of determining a best antenna or antennas for each mobile user.

3. The method of claim 1 wherein the deploying step comprises linking the distributed antennas with the base station.

4. The method of claim 1 wherein the signals are boosted before being received or transmitted from or to the distributed antennas.

5. An access point apparatus for communicating with mobile stations within a cell, the apparatus comprising:
a central unit subsystem having one or more central antenna units;
a distributed antenna subsystem having at least one distributed antenna; and
an auxiliary unit subsystem for interfacing the central subsystem with the distributed antenna subsystem.

6. The apparatus of claim 5 wherein the system has at least one control antenna through which the transmitted control signals can be correctly received by all users within the cell.

7. The apparatus of claim 6 wherein each mobile station has an associated best antenna defined as an antenna providing best signal quality to that mobile station.

8. The apparatus of claim 7 wherein each antenna has its own RF transceiver.

9. The apparatus of claim 7 wherein any two or more antennas share one RF transceiver.

10. The apparatus of claim 5 wherein the central unit subsystem further comprises an RF transceiver, a base band processor and a MAC processor.

11. The apparatus of claim 10 wherein the central unit subsystem operates as a traditional access point.

12. The apparatus of claim 10 wherein the central unit subsystem operates as a time-division duplex (TDD) access point.

13. The apparatus of claim 10 wherein the central unit subsystem operates as a frequency-division duplex (FDD) access point.

14. The apparatus of claim 5 wherein distributed antenna subsystem comprises at least one distributed antenna, its respective attached components, and RF cables.

15. The apparatus of claim 5 wherein the auxiliary unit subsystem comprises a distributed antenna/Tx/Rx switch, a low noise amplifier (LNA), a power amplifier (PA), and a microprocessor.

16. The apparatus of claim 15 wherein the microprocessor of the auxiliary unit operates to:
identify a best antenna or antennas for the mobile stations;
accept a control command from a MAC processor; and
control the switching status of the distributed antenna/Tx/Rx switch.

17. The apparatus of claim 16 wherein the microprocessor of the auxiliary unit operates to control the gain of the power amplifier.

18. The apparatus of claim 5 wherein the auxiliary unit subsystem sends and receives signals to and from the central unit subsystem.

19. The apparatus of claim 18 wherein the signals sent and received can be one or more of the following signals: RF signals, IF signals and base band signals.

20. The apparatus of claim 5 wherein the central unit subsystem and the auxiliary unit subsystem are an integrated unit.

21. A method for optimal antenna utilization in a multiple distributed antenna access point (MDA/AP) system implementing a CSMA/CA DCF transmission protocol, the MDA/AP system including one or more central antennas and at least one distributed antenna, the method comprising steps of:
utilizing one or more antennas as control antennas for transmitting or receiving during an RTS or CTS period; and
selecting one or more antennas for transmitting or receiving signals during a data period.

22. The method of claim 21 wherein the utilizing step comprises utilizing one control antenna or combining multiple control antennas during RTS or CTS transmission and reception periods.

23. The method of claim 21 wherein the selecting step comprises selecting one or more control antennas.

24. The method of claim 21 wherein the selecting step comprises selecting one or N best antennas.

25. The method of claim 21 wherein the selecting step comprises selecting any single or any multiple antennas.

26. The method of claim 21 wherein the selecting step comprises selecting one or more control antennas and N best remaining antennas.

27. The method of claim 21 wherein the same control antenna is utilized for all frames in the period.

28. The method of claim 21 wherein the control antenna can be different from frame to frame.

29. The method of claim 21 wherein the MDA/AP system operates in a time-division duplex (TDD) mode.

30. The method of claim 21 wherein the MDA/AP system operates in a frequency-division duplex (FDD) mode.
